(19) United States
(12) Patent Application Publication
(10) Pub. No.: US 2025/0173780 A1
(43) Pub. Date: May 29, 2025

(54) METHOD FOR ASSET CREDITING, FUNDING, DEPOSITING, AUCTIONING AND STOCK EXCHANGE

(71) Applicants: Serhakan Piyade, Istanbul (TR); Yilmaz Dal, Istanbul (TR)

(72) Inventors: Serhakan Piyade, Istanbul (TR); Yilmaz Dal, Istanbul (TR)

(21) Appl. No.: 18/522,258

(22) Filed: Nov. 29, 2023

(51) Int. Cl. G06Q 30/08; G06Q 30/0283

(52) U.S. Cl. CPC G06Q 30/08; G06Q 30/0283

(57) ABSTRACT

A method for asset crediting, funding, depositing, auctioning and stock exchange is provided. Current owners of precious metals, precious and semi-precious stones, jewelry and artistic assets receive a different service from the authorized body following the valuation report to be provided by the expertise committee. These are pawned as a credit facility according to the Obligations and Commercial Law of the location of the service provided/sold and the associated complementary law and their reimbursement are received as security by the authorized body after the payment of credit. There is a sequence of financial transactions that create added value for the asset owners in a short time. Precious assets taken as security are shown as collateral and credited by the international funding and insurance companies. Funding companies insure these assets as collateral while insurance companies pay a deposit fee to the authorized body providing the depositing service for the movable assets.

### TECHNICAL FIELD

The present invention concerns a method for asset crediting, funding, depositing, auctioning and stock exchange. The current owners of precious metals, precious and semi-precious stones, jewelry and artistic assets (movable and precious assets that do not require registration according to the Obligations and Commercial Law of the location of the service provided/sold and the associated complementary law) will receive a different service from the authorized body following the valuation report to be provided by the expertise committee. These will be pawned as a credit facility according to the Obligations and Commercial Law of the location of the service provided/sold and the associated complementary law and their reimbursement will be received as security by the authorized body after the payment of credit. There will be a sequence of financial transactions that will create added value for the asset owners in a short time. Precious assets taken as security will be shown as collateral and credited by the international funding and insurance companies. Funding companies will insure these assets as collateral while insurance companies will pay a deposit fee to the authorized body providing the depositing service for the movable assets. The asset owners will pay a service charge to the authorized body in return for the inclusion of assets in the auction. They will be able to sell the assets at their real value to the authorized body. The assets will be deposited for a fee in a safe environment appropriate for the qualities of the precious assets without destroying their original structure as long as they demand. The issuer companies will apply to the stock exchange institutions, the Capital Markets Board and A Borsa authorized bodies of the country to which they will provide service with the aim of offering the precious and semi-precious stones, jewelry and artistic assets to public. They will obtain approval for the asset guaranteed security (nominal) value and number, and for issuing in bearer form of the assets to be offered to public.

### BACKGROUND

The present invention concerns a working method to create an added value for asset owners in a short time as well as offering services such as asset crediting, funding, depositing, auctioning and stock exchange following the asset valuation report to be provided by the expertise committee. It offers a wide range of services to both buyers and sellers including precious and semi-precious stones, vintage jewelry, and ornaments, works of art, articles of virtu, antique carpets and rugs, and antiques and artefacts from past civilizations.

The present working methods have been examined and no application could be found providing all these solutions together.

As an example to the state of the art, US patent document no US2018330432A1 describes a pricing and commissioning system for the art market. It does not refer to any service such as method for asset crediting, funding, depositing, auctioning and stock exchange for precious and semi-precious stones, jewelry, and artistic assets.

Another example to the state of the art is Chinese patent document no CN106920160A which describes online auction trade system for works of art. It does not refer to any service such as method for asset crediting, funding, depositing, auctioning and stock exchange for precious and semi-precious stones, jewelry, and artistic assets.

As a result, a detailed working method is developed due to the inadequacy of the solutions referred to in the aforementioned documents in this field.

### SUMMARY

The specialized experts will prepare a valuation report as a result of a highly detailed investigation and research of the precious metals, precious and semi-precious stones, jewelry and artistic assets. Owners of artistic assets such as vintage jewelry and ornaments, works of art, articles of virtu, antique carpets and rugs, and antiques and artefacts from past civilizations will apply to the expertise committee as an asset owner or collector. The expertise committee will determine the estimated value after evaluating information like the condition, quality, rareness, provenance of the artistic asset, the person it is made for and the person who uses it.

The authorized body will transfer the asset identification information to the computer after approving the number and estimated value of the artistic assets to be auctioned. The authorized body entitles the auctioneer company after evaluating the file information registered with the computer. The auction manager will request the identification information of the precious and semi-precious stones, jewelry, and artistic assets as a presentation file. In the auction house, the auction manager will sell the assets to the participant at hammer price through open bidding with estimated value. Participants will be able to access necessary information regarding the assets offered for sale via a web page. Buy and sell order transactions of the assets offered for sale will be carried out in the transaction platform with a defined algorithm.

In the auction house, the asset sale price will be determined by adding commission and tax amounts to the hammer price for the participant who offers the highest bid through open bidding with the asset's estimated price. The microprocessor will transfer the asset's hammer price value to the investment account of the asset owner and the commission amounts to be received by the authorized body and the auctioneer company for the asset's hammer price to their investment accounts registered with the transaction platform.

Before the auction begins, participants will participate in the sale in the auction hall carried out live via internet by entering the participation code and auction number on the auction department page. In the online auction hall, the asset sale price will be determined by adding commission and tax amounts to the bid for the participant who offers the highest bid through open bidding with the asset's estimated price. The microprocessor will transfer the asset's bid value to the investment account of the asset owner and the commission amounts to be received by the authorized body and the auctioneer company for the asset's bid to their investment accounts registered with the transaction platform.

On A Borsa, there will be a stock exchange where precious and semi-precious stones, jewelry and artistic assets will be traded. The issuer company will apply to the authorized body of A Borsa to offer assets to public. The authorized body of A Borsa will evaluate the application and register it as issuer company after approval. The expertise committee will determine the estimated value of each asset in the collection of the issuer company.

The authorized body of A Borsa will transfer the estimated value of each asset in the collection to the computer after approving the asset owners and asset identification information. The microprocessor collects each asset's estimated value in the collection and then finds the asset's price of issue and registers it. It will find the asset fund value by multiplying each asset's estimated value by 100 and then dividing by its price of issue and then register this. It will find the (nominal) value of the asset guaranteed security by dividing the asset's price of issue by the number of the asset guaranteed securities and then register this.

The authorized body of A Borsa will carry out the quota transaction of the asset guaranteed securities on A Borsa. The microprocessor will transfer the estimated value of each asset to the investment account of the asset owner registered with the transaction platform after the issuing of asset guaranteed securities.

The account owners will be able to buy with the (nominal) value of the asset guaranteed security on the date of entering the exchange list. Beginning from the date of entering the exchange list until the date of exiting from it, they will invest by buying at the asset's current stock exchange price while it is being traded on A Borsa. Buy and sell order transactions for the asset guaranteed securities will be carried out with a defined algorithm on the transaction platform through stockbrokers, commercial banks, and investment and development banks. The account owners will be able to buy and sell the asset traded on A Borsa at its current stock exchange price when they want to buy or sell asset guaranteed securities.

On the date of asset's exiting the exchange list, the asset guaranteed securities will be removed from the A Borsa exchange list and closed for transactions. On the date of asset's exiting the exchange list, the microprocessor will find the asset stock exchange value by multiplying the final quotation of the asset on its last transaction day with the number of asset guaranteed securities and then register this. The authorized body of A Borsa will declare the auction beginning/ending date after the approval of asset's stock exchange value. The microprocessor will find the asset's auction opening price by multiplying the asset's stock exchange value with each asset fund value and then register this.

The auctioneer company will realize the live auction in the stock exchange auction house. The auction manager will offer for sale each asset through open bidding at its auction opening price. The auction manager will sell to the participant who offers the highest bid for each asset at its hammer price. The participant will buy at asset's sale price determined by adding commission and tax amounts to the hammer price. Each asset that could not be sold through open bidding will be sold to the secondary markets at its auction opening price. The microprocessor will transfer the commission amounts to be received for the asset's hammer price by the authorized body and the auctioneer company for the asset's hammer price to their investment accounts registered with the transaction platform.

The microprocessor will find the asset's auction value by adding the hammer price of each asset that is sold and the auction opening price of each asset that is not sold and then register this. It will find the asset's auction earning value by subtracting the asset's stock exchange value from the asset's auction value and then register this. It will find the asset owner's earning value by multiplying the auction earning value with a defined percentage and then register this. It will find the account owner's earning value by subtracting the asset owner's earning value from the auction earning value and then register this. It will find each asset's earning value by multiplying asset owner's earning value with each asset's fund value and then register this. It will transfer each asset's earning value to the investment account of the asset owner registered with the transaction platform.

The microprocessor will find the (final) value of the asset guaranteed security by adding the asset's price of issue to the account owner's earning value and then dividing this by the number of the asset guaranteed securities and then register this. It will find the transaction closing values by multiplying the number of the asset guaranteed securities held by the account owners on the date of asset's exiting the exchange list with the (final) value of the asset guaranteed security and then register this. The transaction closing values of the account owners will be transferred to their investment accounts registered with the transaction platform.

### BRIEF DESCRIPTION OF THE DRAWINGS

The present invention “Method of Asset Crediting, Funding, Depositing, Auctioning and Stock Exchange” is displayed in the attached figures.

FIG. 1: Representative figure illustrating “the authorized body of Borsa A transferring the estimated value of each asset in the collection to the computer”.

FIG. 2: Representative figure illustrating “the microprocessor adding each asset's estimated value in the collection and finding the price of issue”.

FIG. 3: Representative figure illustrating “the microprocessor finding the asset fund value by multiplying each asset's estimated value by 100 and then dividing it by its price of issue”.

FIG. 4: Representative figure illustrating “the microprocessor finding the (nominal) value of the asset guaranteed security by dividing the asset's price of issue by the number of the asset guaranteed securities”.

FIG. 5: Representative figure illustrating “the microprocessor transferring the estimated value of each asset to the investment account of the asset owner registered with the transaction platform after issuing the asset guaranteed securities.

FIG. 6: Representative figure illustrating “the microprocessor finding the asset stock exchange value by multiplying the final quotation of the asset on its last transaction day with the number of asset guaranteed securities on the date of asset's exiting the exchange list”.

FIG. 7: Representative figure illustrating “the microprocessor finding the asset's auction opening price by multiplying the asset's stock exchange value with each asset fund value”.

FIG. 8: Representative figure illustrating “the auction manager selling to the participant who offers the highest bid for each asset at its hammer price”.

FIG. 9: Representative figure illustrating “the microprocessor finding the asset's auction value by adding the hammer price of each asset that is sold and the auction opening price of each asset that is not sold”.

FIG. 10: Representative figure illustrating “the microprocessor finding the asset's auction earning value by subtracting the asset's stock exchange value from the asset's auction value”.

FIG. 11: Representative figure illustrating “the microprocessor finding the asset owner's earning value by multiplying the auction earning value with a defined percentage”.

FIG. 12: Representative figure illustrating “the microprocessor finding the account owner's earning value by subtracting the asset owner's earning value from the auction earning value”.

FIG. 13: Representative figure illustrating “the microprocessor finding each asset earning value by multiplying the asset owner's earning value with each asset fund value”.

FIG. 14: Representative figure illustrating “the microprocessor transferring each asset earning value to the investment account of the asset owner registered with the transaction platform”.

FIG. 15: Representative figure illustrating “the microprocessor finding the (final) value of the asset guaranteed security by adding the asset's price of issue to the account owner's earning value and then dividing this by the number of the asset guaranteed securities”.

FIG. 16: Representative figure illustrating “the microprocessor finding the transaction closing values by multiplying the number of the asset guaranteed securities held by the account owners on the date of asset's exiting the exchange list with the (final) value of the asset guaranteed security”.

FIG. 17: Representative figure illustrating “the microprocessor transferring the account owner transaction closing values to the investment account registered with the transaction platform”.

FIG. 18: The flow diagram of the transaction steps of “the method for asset crediting, funding, depositing, auctioning and stock exchange”.

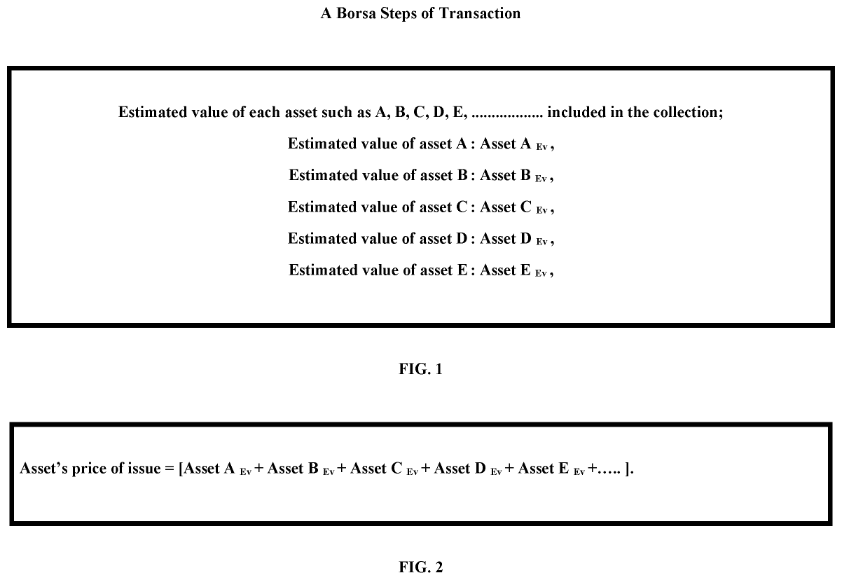

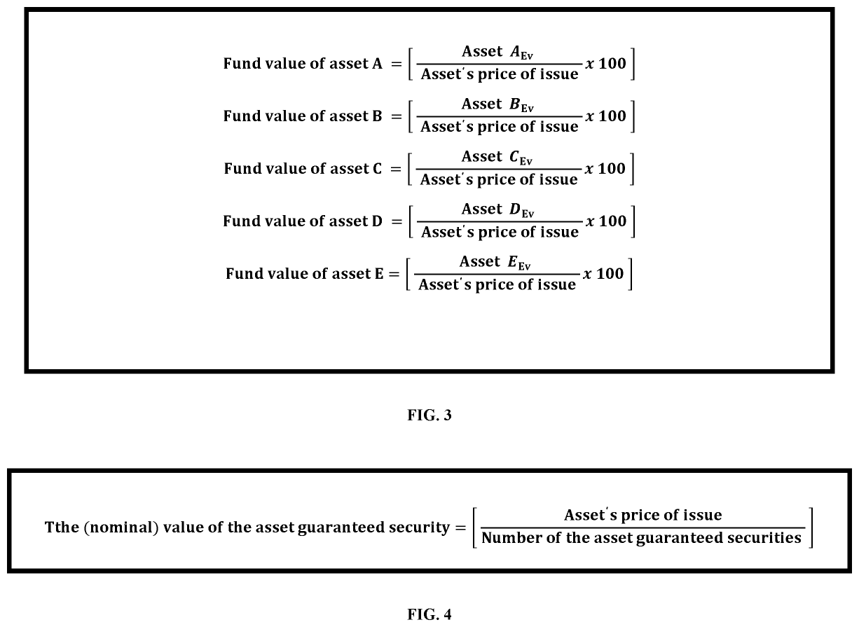

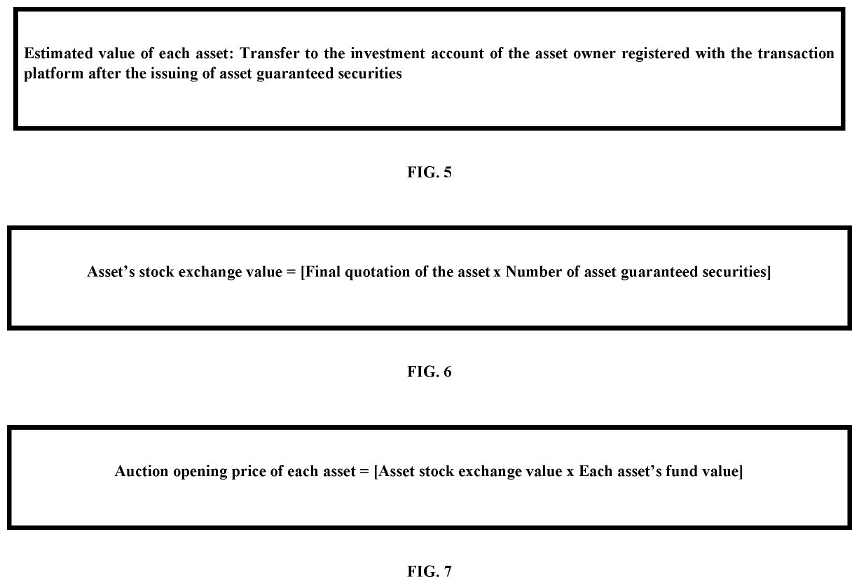

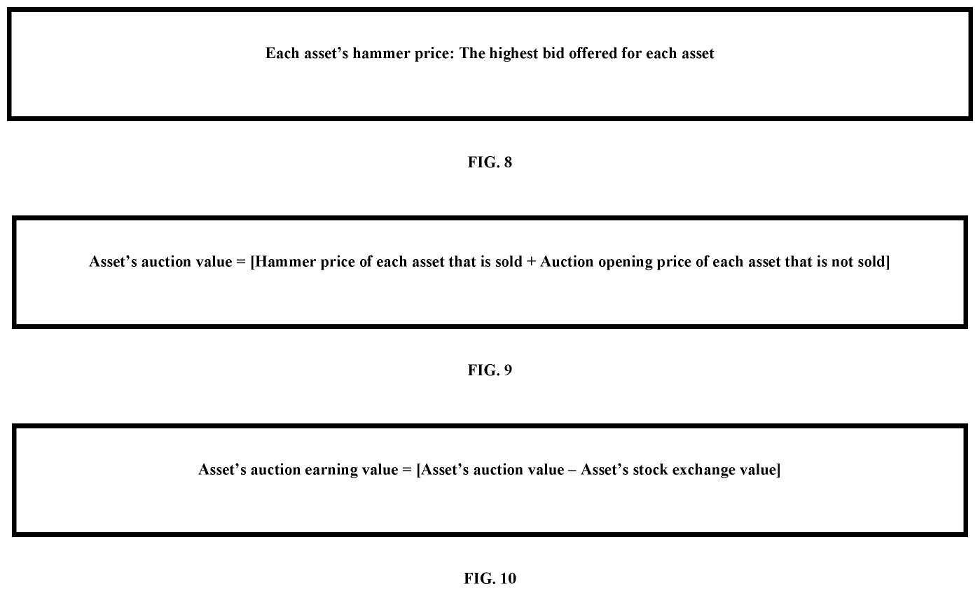

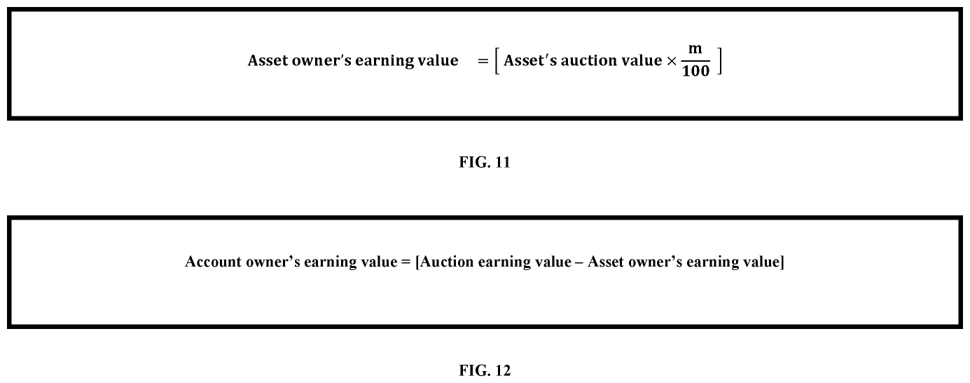

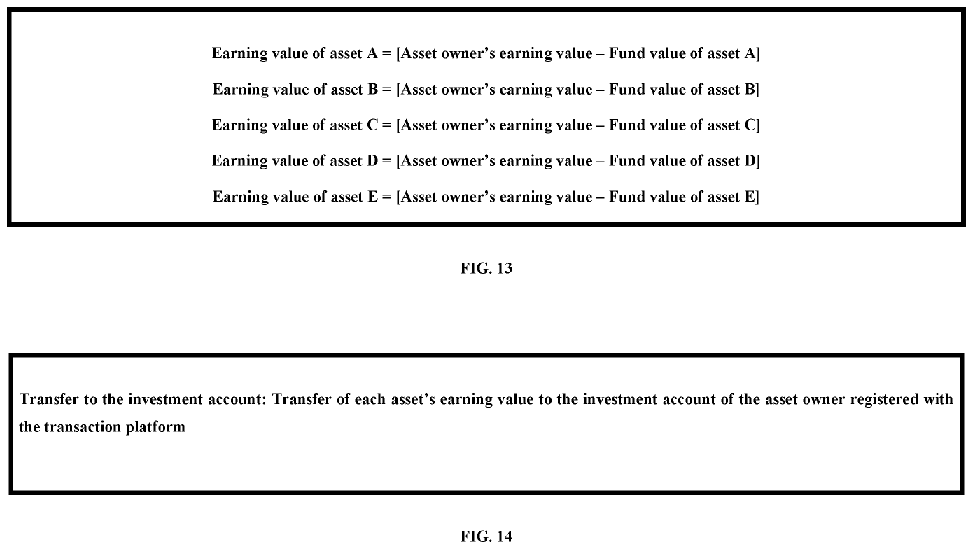

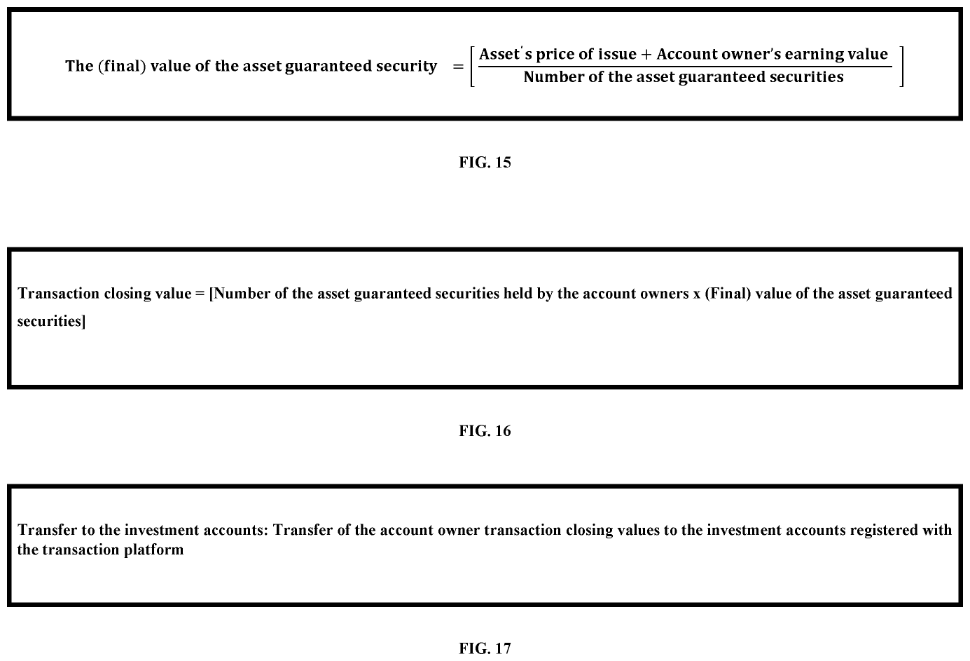

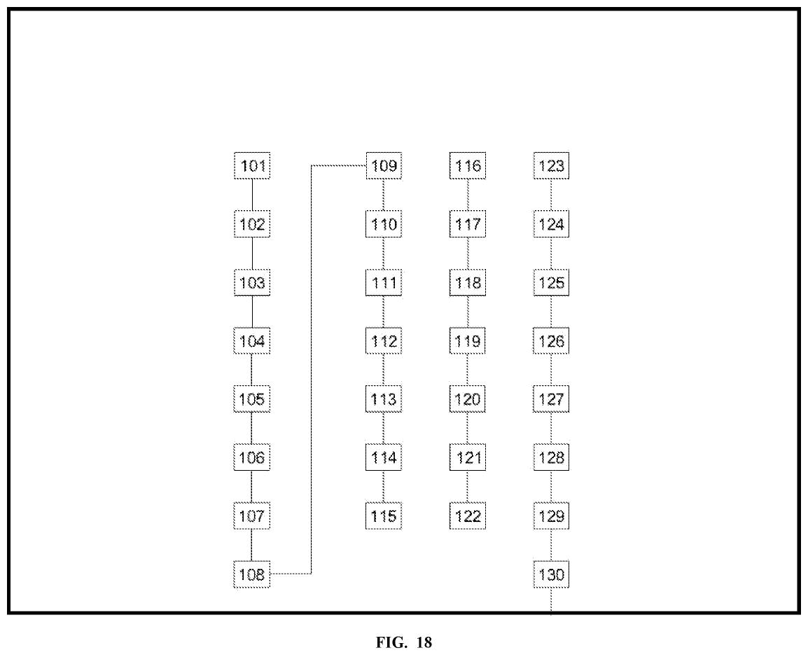

Figures are merely representative and illustrative of the invention. In the description, solely the elements that are illustrative of the invention are emphasized while the elements unnecessary for the clarification of the invention are omitted.

### DESCRIPTION OF THE REFERENCES OF THE METHOD

1. Authorized body
2. Expertise committee
3. Asset owner
4. Auctioneer company
5. Auction house
6. Auction manager
7. Transaction platform
8. Microprocessor
9. Online auction hall
10. A Borsa
11. Issuer company

### Description of the Transaction Steps

101. The current owners of precious metals, precious and semi-precious stones, jewelry and artistic assets (movable and precious assets that do not require registration according to the Obligations and Commercial Law of the location of the service provided/sold and the associated complementary law) will receive a different service from the authorized body (1) following the valuation report to be provided by the expertise committee (2),
102. These will be pawned as a credit facility according to the Obligations and Commercial Law of the location of the service provided/sold and the associated complementary law and their reimbursement will be received as security by the authorized body (1) after the payment of credit. There will be a sequence of financial transactions that will create added value for the asset owners (3) in a short time.
103. Precious assets taken as security will be shown as collateral and credited by the international funding and insurance companies. Funding companies insure these assets as collateral while insurance companies pay a deposit fee to the authorized body (1) providing the depositing service for the movable assets.
104. The asset owners (3) will pay a service charge to the authorized body (1) in return for the inclusion of assets in the auction. They will be able to sell the assets at their real value to the authorized body (1). The assets will be deposited for a fee in a safe environment appropriate for the qualities of the precious assets without destroying their original structure as long as they demand,
105. The issuer companies (11) will apply to the stock exchange institutions, the Capital Markets Board and A Borsa authorized bodies (1) of the country to which they will provide service with the aim of offering the precious and semi-precious stones, jewelry and artistic assets to public. They will obtain approval for the asset guaranteed security (nominal) value and number, and for issuing in bearer form of the assets to be offered to public,
106. The specialized experts will prepare a valuation report as a result of a highly detailed investigation and research of the precious metals, precious and semi-precious stones, jewelry and artistic assets. They will be authorized in the expertise committee (2) as they have adequate knowledge and experience. Required information and documents will be provided to the expertise committee (2) by working with private expertise companies operating in this field,
107. Owners of artistic assets such as vintage jewelry and ornaments, works of art, articles of virtu, antique carpets and rugs, antiques and artefacts from past civilizations will apply to the expertise committee (2) as an asset owner (3) or collector. The identification information of the artistic asset owner (3) will not be known even to the expertise committee (2) and the specialized expert who will prepare the valuation report. The specialized expert will never bid for the artistic asset. Valuation report will be prepared as a result of the investigation and research on the artistic asset,
108. The expertise committee (2) will determine the estimated value after evaluating information like the condition, quality, rareness, provenance of the artistic asset, the person it is made for and the person who uses it. The authorized body (1) will transfer the asset identification information to the computer after approving the estimated value of each artistic asset to be auctioned and the asset number,
109. The auctioneer company (4) will prepare the file including information such as identification information of the precious and semi-precious stones, jewelry and artistic assets to be offered for sale, asset valuation report, asset's estimated value, information about auctioneer company (4), auction house (5), operating cost, auction manager (6) fee, transportation fee, private security fee, staff and employee fee and commission fee and then will send this file to the authorized body (1). The authorized body (1) will entitle the auctioneer company (4) after evaluating the file information registered with the computer,
110. The auctioneer company (4) will print the asset's identification information such as auction house (5), seller's name, asset's estimated value, name of the work of art and artist, date of the work of art, category of the work of art, technical information, dimensions of the work of art, lot no, asset valuation report no, auctioneer company (4), starting/ending date of the auction on the label attached to the precious and semi-precious stones, jewelry and artistic assets,
111. The photographers commissioned at the auction house (5) will take photos of precious and semi-precious stones, jewelry and artistic assets and prepare an auction catalogue. Auctioneer company (4) will share the auction catalogue through media. It will place the assets in a planned and programmed way in the auction house (5) with due diligence and open a display exhibition before the auction. Participants will examine the displayed assets and gain more detailed information,
112. The auction manager (6) will request the identification information of the precious and semi-precious stones, jewelry, and artistic assets as a presentation file. The auction manager will offer the assets for sale in the auction house (5) through open bidding/open underbidding as stated in the auction specifications. In the auction house (5), he/she will sell the assets to the participant at hammer price through open bidding with estimated value, Participants will be able to access necessary information regarding the assets offered for sale via a web page. Buy and sell order transactions of the assets offered for sale will be carried out in the transaction platform (7) with a defined algorithm,
113. The auctioneer company (4) will not offer only precious and semi-precious stones, jewelry, and artistic assets for sale in the auction house and it will be able to offer assets from different sectors for sale, as well. The expertise committee (2) will determine an estimated value for the real estate, automobile, and liquidated asset to be auctioned from other sectors. The authorized body (1) will transfer the asset identification information to the computer after approving the estimated value of each asset and the asset number to be auctioned. The auctioneer company (4) may carry out sales in more than one auction house (5) simultaneously or at different times,
114. The asset owner (3) will be able to give instruction to offer for sale and sell in the desired auction house (5) the precious and semi-precious stones, jewelry and artistic assets kept in the storehouse through the transaction platform (7). The difference from other current auction houses (5) is that the sale of assets in the central registration system is ordered and these are offered for sale in the auction house (5). When the participant desires to buy the assets offered for sale through open bidding in the auction house (5), this is realized easily on the transaction platform (7),
115. In the auction house (5), the asset sale price will be determined by adding commission and tax amounts to the hammer price for the participant who offers the highest bid through open bidding with the asset's estimated price. The commission ratio to be received by the authorized body (1) and the auctioneer company (4) is defined in the auction specification. The microprocessor (8) will transfer the asset's hammer price value to the investment account of the asset owner (3) and the commission amounts to be received by the authorized body (1) and the auctioneer company (4) for the asset's hammer price to their investment accounts registered with the transaction platform (7),
116. The participant will be able to see and examine the assets offered for sale in the online auction hall (9) physically in the gallery hall. The participant will become a member to the online auction hall (9) via the web site and choose the auction calendar to participate. A participant code and auction number will be sent when the registration is approved. The participant will make a down payment as defined in the registered auction hall. The amount of the down payment will differ according to the sales department. Before the auction begins, participants will participate in the sale in the auction hall carried out live via internet by entering the participation code and auction number on the auction department page,
117. In the online auction hall (9), the asset sale price will be determined by adding commission and tax amounts to the bid for the participant who offers the highest bid through open bidding with the asset's estimated price. The commission ratio to be received for the bid by the authorized body (1) and the auctioneer company (4) is defined in the auction specification. The microprocessor (8) will transfer the asset's bid value to the investment account of the asset owner (3) and the commission amounts to be received by the authorized body (1) and the auctioneer company (4) for the asset's bid to their investment accounts registered with the transaction platform (7). Only the buyer's information will be added to the asset's identification information. The buyer may keep the bought asset in the storehouse or offer for sale again. The asset gains value without being damaged and by continuously changing hands,
118. For asset owners (3), the issue of conservation and restoration is a primary concern. The restoration company will carry out the repair and maintenance processes with due diligence and without harming the original structure of the artistic asset. The specialized experts will carry out conservation processes of the artistic assets kept in storehouses with defined periods and ensure these assets to be more precious. All assets kept in the storehouses will be actively controlled 24/7 with the help of a cutting-edge technological security system,
119. The precious and semi-precious stones, jewelry and artistic assets will be kept in storehouses after the most comprehensive private insurance contract is made. When any damage is detected with the assets, the cost of restoration will be reimbursed by the insurance company. The asset owner (3) will receive the down payment specified in the contract as reimbursement if the asset is stolen or lost. Various processes will be covered by the private insurance policy such as defining every kind of fire and natural disaster risk groups that can occur in the storehouse and the auction house, transportation processes, maintenance and repair processes, delivery of the damage assessment report, prevention of theft, legal consultancy and working with the best reassurance companies,
120. The auctioneer company (4) will draw up a private insurance contract for all risky situations that can occur during and after transportation of the precious and semi-precious stones, jewelry, and artistic assets to be sold to the auction house (5). The authorized body (1) will secure the contractual rights of the beneficiary by drawing up an asset pledge contract due to the risky situations that can occur with the assets. Assets are offered for sale by drawing up a private insurance contract,
121. All transactions of the assets kept in storehouses will be registered with the accounts opened on behalf of those assets. Transaction fees such as specialized expertise fee, asset's estimated value, asset's pledge contract amount, the deposited down payment, authorized body (1) and auctioneer company (4) commission rate, the received tax amount, private insurance policy fee, conservation and restoration expenses, transportation and storage fees will be registered with the account opened on behalf of the asset. If the asset is received by the asset owner (3) or sold, the account opened on behalf of the asset will be removed from the registration and closed,
122. The authorized body (1) will give a credit rating according to the organization and sales performance of the auctioneer companies (4) in the auction house (5) and online auction halls (9). It will decide whether it will be an auctioneer company (4) again or not. It will evaluate the credit ratings and allow the auctioneer companies (4) to carry out sales in A Borsa auction houses (5) according to this,
123. On A Borsa (10), there will be a stock exchange where precious and semi-precious stones, jewelry and artistic assets will be traded. The issuer company (11) will apply to the authorized body (1) of A Borsa to offer assets to public. The authorized body (1) of A Borsa will evaluate the application and register it as issuer company (11) after approval. The expertise committee (2) will determine the estimated value of each asset in the collection of the issuer company (11). The issuer company (11) will prepare a file including the asset identification information of the collection to be offered to public and the commission amount to be taken from the asset's value of issue and deliver it to the authorized body (1) of A Borsa,
124. The authorized body (1) of A Borsa will transfer the estimated value of each asset in the collection to the computer after approving the asset owners (3) and asset identification information. The microprocessor (8) will add each asset's estimated value in the collection and find the price of issue of the asset and then register this. It will find the asset fund value by multiplying each asset's estimated value by 100 and then dividing by its price of issue and then register this. It will find the (nominal) value of the asset guaranteed security by dividing the asset's price of issue by the number of the asset guaranteed securities and then register this
125. The issuer company (11) will print on the asset guaranteed securities the identification information of the asset such as the issue date of the asset, barcode of the asset, date of asset's entering/exiting the exchange list, (nominal) value and number of asset guaranteed security with the printing process to be applied. Asset guaranteed securities equal to the asset value of issue will be offered to public. Asset guaranteed securities will be issued in bearer form. The authorized body (1) of A Borsa will carry out the quota transaction of the asset guaranteed securities on A Borsa (10). The microprocessor (8) will transfer the estimated value of each asset to the investment account of the asset owner (3) registered with the transaction platform (7) after issuing the asset guaranteed securities,
126. The account owners will be able to buy with the (nominal) value of the asset guaranteed security on the date of entering the exchange list. Beginning from the date of entering the exchange list until the date of exiting from it, they will invest by buying at the asset's current stock exchange price while it is being traded on A Borsa (10). Buy and sell order transactions for the asset guaranteed securities will be carried out with a defined algorithm on the transaction platform (7) through stockbrokers, commercial banks, and investment and development banks. Account owners will be able to buy and sell the asset traded on A Borsa (10) at its current stock exchange price when they want to buy or sell asset guaranteed securities,
127. Account owners will carry out processes such as monitoring immediate data of the traded asset guaranteed securities and buy-sell order transactions easily and quickly on the transaction platform (7) through A Borsa (10). They will be able to review the volume, depth, simultaneous level analysis of the asset guaranteed securities. Buy and sell orders can be given with an optimum level and transactions can be transferred to A Borsa (10) safely. The status of the given orders will be questioned as pending, realized, cancelled and unrealized. Instructions to improve and cancel the order transactions can be given and information such as the quantity, current value, profit and loss information of the asset guaranteed securities can be accessed through investment account,
128. On the date of asset's exiting the exchange list, the asset guaranteed securities will be removed from the A Borsa (10) exchange list and closed for transactions. On the date of asset's exiting the exchange list, the microprocessor (8) will find the asset stock exchange value by multiplying the final quotation of the asset on its last transaction day with the number of asset guaranteed securities and then register this. The authorized body (1) of A Borsa will declare the auction beginning/ending date after the approval of asset stock exchange value. The microprocessor (8) will find the asset's auction opening price by multiplying the asset stock exchange value with each asset fund value and then register this,
129. The auctioneer company (4) will print asset's identification information such as each asset's auction opening price, asset owner (3), name of the work of art and artist, date of the work of art, category of the work of art, technical information, dimensions of the work of art, lot no, asset valuation report no, auctioneer company (4), and starting/ending date of the auction on the label attached to the assets included in the collection. It will open a display exhibition in the stock exchange auction house (5) for the assets included in the collection that is removed from the A Borsa (10) exchange list. Participants will examine the displayed collection assets in the stock exchange auction house (5) to gain more detailed information,
130. The auctioneer company (4) will realize the live auction in the stock exchange auction house (5). The auction manager (6) will offer for sale each asset through open bidding at its auction opening price. The auction manager will sell to the participant who offers the highest bid for each asset at its hammer price. The participant will buy at asset's sale price determined by adding commission and tax amounts to the hammer price. Each asset that could not be sold through open bidding will be sold to the secondary markets at its auction opening price. The microprocessor (8) will transfer the commission amounts to be received for the asset hammer price by the authorized body (1) and the auctioneer company (4) for the asset's hammer price to their investment accounts registered with the transaction platform (7).
131. The microprocessor (8) will find the asset's auction value by adding the hammer price of each asset that is sold and the auction opening price of each asset that is not sold and then register this. It will find the asset's auction earning value by subtracting the asset's stock exchange value from the asset's auction value and then register this. It will find the asset owner's earning value by multiplying the auction earning value with a defined percentage and then register this. It will find the account owner's earning value by subtracting the asset owner's earning value from the auction earning value and then register this. It will find each asset's earning value by multiplying asset owner's earning value with each asset's fund value and then register this. It will transfer each asset's earning value to the investment account of the asset owner (3) registered with the transaction platform (7),
132. The microprocessor (8) will find the (final) value of the asset guaranteed security by adding the asset's price of issue to the account owner's earning value and dividing this by the number of the asset guaranteed securities and then register this. It will find the transaction closing values by multiplying the number of the asset guaranteed securities held by the account owners on the date of asset's exiting the exchange list with the (final) value of the asset guaranteed security and then register this. It will transfer the account owner transaction closing values to the investment accounts registered with the transaction platform (7),

### DETAILED DESCRIPTION OF THE EMBODIMENTS

The current owners of precious metals, precious and semi-precious stones, jewelry and artistic assets (movable and precious assets that do not require registration according to the Obligations and Commercial Law of the location of the service provided/sold and the associated complementary law) will receive a different service from the authorized body (1) following the valuation report to be provided by the expertise committee (2).

These will be pawned as a credit facility according to the Obligations and Commercial Law of the location of the service provided/sold and the associated complementary law and their reimbursement will be received as security by the authorized body (1) after the payment of credit. There will be a sequence of financial transactions that will create added value for the asset owners (3) in a short time.

Precious assets taken as security will be shown as collateral and credited by the international funding and insurance companies. Funding companies insure these assets as collateral while insurance companies pay a deposit fee to the authorized body (1) providing the depositing service for the movable assets.

The asset owners (3) will pay a service charge to the authorized body (1) in return for the inclusion of assets in the auction. They will be able to sell the assets at their real value to the authorized body (1). The assets will be deposited for a fee in a safe environment appropriate for the qualities of the precious assets without destroying their original structure as long as they demand.

The issuer companies (11) will apply to the stock exchange institutions, the Capital Markets Board and A Borsa authorized bodies (1) of the country to which they will provide service with the aim of offering the precious and semi-precious stones, jewelry and artistic assets to public. They will obtain approval for the asset guaranteed security (nominal) value and number, and for issuing in bearer form of the assets to be offered to public.

The specialized experts will prepare a valuation report as a result of a highly detailed investigation and research of the precious metals, precious and semi-precious stones, jewelry and artistic assets. They will be authorized in the expertise committee (2) as they have adequate knowledge and experience. Required information and documents will be provided to the expertise committee (2) by working with private expertise companies operating in this field.

Owners of artistic assets such as vintage jewelry and ornaments, works of art, articles of virtu, antique carpets and rugs, antiques and artefacts from past civilizations will apply to the expertise committee (2) as an asset owner (3) or collector. The identification information of the artistic asset owner (3) will not be known even to the expertise committee (2) and the specialized expert who will prepare the valuation report. The specialized expert will never bid for the artistic asset. Valuation report will be prepared as a result of the investigation and research on the artistic asset.

The expertise committee (2) will determine the estimated value after evaluating information like the condition, quality, rareness, provenance of the artistic asset, the person it is made for and the person who uses it. The authorized body (1) will transfer the asset identification information to the computer after approving the estimated value of each artistic asset to be auctioned and the asset number.

The auctioneer company (4) will prepare the file including information such as identification information of the precious and semi-precious stones, jewelry and artistic assets to be offered for sale, asset valuation report, asset's estimated value, information about auctioneer company (4), auction house (5), operating cost, auction manager (6) fee, transportation fee, private security fee, staff and employee fee and commission fee and then will send this file to the authorized body (1). The authorized body (1) will entitle the auctioneer company (4) after evaluating the file information registered with the computer.

The auctioneer company (4) will print asset's identification information such as auction house (5), seller's name, asset's estimated value, name of the work of art and artist, date of the work of art, category of the work of art, technical information, dimensions of the work of art, lot no, asset valuation report no, auctioneer company (4), starting/ending date of the auction on the label attached to the precious and semi-precious stones, jewelry and artistic assets.

The photographers commissioned at the auction house (5) will take photos of precious and semi-precious stones, jewelry and artistic assets and prepare an auction catalogue. Auctioneer company (4) will share the auction catalogue through media. It will place the assets in a planned and programmed way in the auction house (5) with due diligence and open a display exhibition before the auction. Participants will examine the displayed assets and gain more detailed information.

The auction manager (6) will request the identification information of the precious and semi-precious stones, jewelry and artistic assets as a presentation file. The auction manager will offer the assets for sale in the auction house (5) through open bidding/open underbidding as stated in the auction specifications. In the auction house (5), he/she will sell the assets to the participant at hammer price through open bidding with estimated value, Participants will be able to access necessary information regarding the assets offered for sale via a web page. Buy and sell order transactions of the assets offered for sale will be carried out in the transaction platform (7) with a defined algorithm.

The auctioneer company (4) will not offer only precious and semi-precious stones, jewelry and artistic assets for sale in the auction house and it will be able to offer assets from different sectors for sale, as well. The expertise committee (2) will determine an estimated value for the real estate, automobile and liquidated asset to be auctioned from other sectors. The authorized body (1) will transfer the asset identification information to the computer after approving the estimated value of each asset and the asset number to be auctioned. The auctioneer company (4) will be able to carry out sales in more than one auction house (5) simultaneously or at different times.

The asset owner (3) will be able to give instruction to offer for sale and sell in the desired auction house (5) the precious and semi-precious stones, jewelry and artistic assets kept in the storehouse through the transaction platform (7). The difference from other current auction houses (5) is that the sale of assets in the central registration system is ordered and these are offered for sale in the auction house (5). When the participant desires to buy the assets offered for sale through open bidding in the auction house (5), this is realized easily on the transaction platform (7).

In the auction house (5), the asset sale price will be determined by adding commission and tax amounts to the hammer price for the participant who offers the highest bid through open bidding with the asset's estimated price. The commission ratio to be received by the authorized body (1) and the auctioneer company (4) is defined in the auction specification. The microprocessor (8) will transfer the asset's hammer price value to the investment account of the asset owner (3) and the commission amounts to be received by the authorized body (1) and the auctioneer company (4) for the asset's hammer price to their investment accounts registered with the transaction platform (7).

The participant will be able to see and examine the assets offered for sale in the online auction hall (9) physically in the gallery hall. The participant will become a member to the online auction hall (9) via the web site and choose the auction calendar to participate. A participant code and auction number will be sent when the registration is approved. The participant will make a down payment as defined in the registered auction hall. The amount of the down payment will differ according to the sales department. Before the auction begins, participants will participate in the sale in the auction hall carried out live via internet by entering the participation code and auction number on the auction department page.

In the online auction hall (9), the asset sale price will be determined by adding commission and tax amounts to the bid for the participant who offers the highest bid through open bidding with the asset's estimated price. The commission ratio to be received for the bid by the authorized body (1) and the auctioneer company (4) is defined in the auction specification. The microprocessor (8) will transfer the asset's bid value to the investment account of the asset owner (3) and the commission amounts to be received by the authorized body (1) and the auctioneer company (4) for the asset's bid to their investment accounts registered with the transaction platform (7). Only the buyer's information will be added to the asset's identification information. The buyer may keep the bought asset in the storehouse or offer for sale again. The asset will gain value without being damaged and by continuously changing hands.

For asset owners (3), the issue of conservation and restoration is a primary concern. The restoration company will carry out the repair and maintenance processes with due diligence and without harming the original structure of the artistic asset. The specialized experts will carry out conservation processes of the artistic assets kept in storehouses with defined periods and ensure these assets to be more precious. All assets kept in the storehouses will be actively controlled 24/7 with the help of a cutting-edge technological security system.

The precious and semi-precious stones, jewelry and artistic assets will be kept in storehouses after the most comprehensive private insurance contract is made. When any damage is detected with the assets, the cost of restoration will be reimbursed by the insurance company. The asset owner (3) will receive the down payment specified in the contract as reimbursement if the asset is stolen or lost. Various processes will be covered by the private insurance policy such as defining every kind of fire and natural disaster risk groups that can occur in the storehouse and the auction house, transportation processes, maintenance and repair processes, delivery of the damage assessment report, prevention of theft, legal consultancy and working with the best reassurance companies.

The auctioneer company (4) will draw up a private insurance contract for all risky situations that can occur during and after transportation of the precious and semi-precious stones, jewelry and artistic assets to be sold to the auction house (5). The authorized body (1) will secure the contractual rights of the beneficiary by drawing up an asset pledge contract due to the risky situations that can occur with the assets. Assets will be offered for sale by drawing up a private insurance contract.

All transactions of the assets kept in storehouses will be registered with the accounts opened on behalf of those assets. Transaction fees such as specialized expertise fee, asset's estimated value, asset's pledge contract amount, the deposited down payment, authorized body (1) and auctioneer company (4) commission rate, the received tax amount, private insurance policy fee, conservation and restoration expenses, transportation and storage fees will be registered with the account opened on behalf of the asset. If the asset is received by the asset owner (3) or sold, the account opened on behalf of the asset will be removed from the registration and closed.

The authorized body (1) will give a credit rating according to the organization and sales performance of the auctioneer companies (4) in the auction house (5) and online auction halls (9). It will decide whether it will be an auctioneer company (4) again or not. It will evaluate the credit ratings and allow the auctioneer companies (4) to carry out sales in A Borsa auction houses (5) according to this.

On A Borsa (10), there will be a stock exchange where precious and semi-precious stones, jewelry and artistic assets will be traded. The issuer company (11) will apply to the authorized body (1) of A Borsa to offer assets to public. The authorized body (1) of A Borsa will evaluate the application and register it as issuer company (11) after approval. The expertise committee (2) will determine the estimated value of each asset in the collection of the issuer company (11). The issuer company (11) will prepare a file including the asset identification information of the collection to be offered to public and the commission amount to be taken from the asset's value of issue and deliver it to the authorized body (1) of A Borsa.

The authorized body (1) of A Borsa will transfer the estimated value of each asset in the collection to the computer after approving the asset owners (3) and asset identification information. The microprocessor (8) will add each asset's estimated value in the collection and find the price of issue of the asset and then register this. It will find the asset fund value by multiplying each asset's estimated value by 100 and then dividing by its price of issue and then register this. It will find the (nominal) value of the asset guaranteed security by dividing the asset's price of issue by the number of the asset guaranteed securities and then register this.

The issuer company (11) will print on the asset guaranteed securities the identification information of the asset such as the issue date of the asset, barcode of the asset, date of asset's entering/exiting the exchange list, (nominal) value and number of asset guaranteed security with the printing process to be applied. Asset guaranteed securities equal to the asset value of issue will be offered to public. Asset guaranteed securities will be issued in bearer form. The authorized body (1) of A Borsa will carry out the quota transaction of the asset guaranteed securities on A Borsa (10). The microprocessor (8) will transfer the estimated value of each asset to the investment account of the asset owner (3) registered with the transaction platform (7) after issuing the asset guaranteed securities.

The account owners will be able to buy with the (nominal) value of the asset guaranteed security on the date of entering the exchange list. Beginning from the date of entering the exchange list until the date of exiting from it, they will invest by buying at the asset's current stock exchange price while it is being traded on A Borsa (10). Buy and sell order transactions for the asset guaranteed securities will be carried out with a defined algorithm on the transaction platform (7) through stockbrokers, commercial banks, and investment and development banks. The account owners will be able to buy and sell the asset traded on A Borsa (10) at its current stock exchange price when they want to buy or sell asset guaranteed securities.

Account owners will carry out processes such as monitoring immediate data of the traded asset guaranteed securities and buy-sell order transactions easily and quickly on the transaction platform (7) through A Borsa (10). They will be able to review the volume, depth, simultaneous level analysis of the asset guaranteed securities. Buy and sell orders can be given with an optimum level and transactions can be transferred to A Borsa (10) safely. The status of the given orders will be questioned as pending, realized, cancelled and unrealized. Instructions to improve and cancel the order transactions can be given and information such as the quantity, current value, profit and loss information of the asset guaranteed securities can be accessed through investment account.

On the date of asset's exiting the exchange list, the asset guaranteed securities will be removed from the A Borsa (10) exchange list and closed for transactions. On the date of asset's exiting the exchange list, the microprocessor (8) will find the asset stock exchange value by multiplying the final quotation of the asset on its last transaction day with the number of asset guaranteed securities and then register this. The authorized body (1) of A Borsa will declare the auction beginning/ending date after the approval of asset stock exchange value. The microprocessor (8) will find the asset's auction opening price by multiplying the asset's stock exchange value with each asset fund value and then register this. The auctioneer company (4) will print asset's identification information such as each asset's auction opening price, asset owner (3), name of the work of art and artist, date of the work of art, category of the work of art, technical information, dimensions of the work of art, lot no, asset valuation report no, auctioneer company (4), and starting/ending date of the auction on the label attached to the assets included in the collection. It will open a display exhibition in the stock exchange auction house (5) for the assets included in the collection that is removed from the A Borsa (10) exchange list. Participants will examine the displayed collection assets in the stock exchange auction house (5) to gain more detailed information.

The auctioneer company (4) will realize the live auction in the stock exchange auction house (5). The auction manager (6) will offer for sale each asset through open bidding at its auction opening price. The auction manager will sell to the participant who offers the highest bid for each asset at its hammer price. The participant will buy at asset's sale price determined by adding commission and tax amounts to the hammer price. Each asset that could not be sold through open bidding will be sold to the secondary markets at its auction opening price. The microprocessor (8) will transfer the commission amounts to be received for the asset hammer price by the authorized body (1) and the auctioneer company (4) for the asset's hammer price to their investment accounts registered with the transaction platform (7).

The microprocessor (8) will find the asset's auction value by adding the hammer price of each asset that is sold and the auction opening price of each asset that is not sold and then register this. It will find the asset's auction earning value by subtracting the asset's stock exchange value from the asset's auction value and then register this. It will find the asset owner's earning value by multiplying the auction earning value with a defined percentage and then register this. It will find the account owner's earning value by subtracting the asset owner's earning value from the auction earning value and then register this. It will find each asset's earning value by multiplying asset owner's earning value with each asset's fund value and then register this. It will transfer each asset's earning value to the investment account of the asset owner (3) registered with the transaction platform (7).

The microprocessor (8) will find the (final) value of the asset guaranteed security by adding the asset's price of issue to the account owner's earning value and dividing this by the number of the asset guaranteed securities and then register this. It will find the transaction closing values by multiplying the number of the asset guaranteed securities held by the account owners on the date of asset's exiting the exchange list with the (final) value of the asset guaranteed security and then register this. The transaction closing values of the account owners will be transferred to their investment accounts registered with the transaction platform.

The authorized body (1) will have a broad structuring. The authorized body (1) will have various departments that are different from each other. Each department will have a different function. Each department will ensure that the authorized body (1) works more efficiently.

The best auctioneer company (4) will be announced after evaluating the number of auctions conducted successfully by the auctioneer companies (4) in a year and the credit ratings given to the companies. There will be a great gain for the auction house (5) and the assets to be offered for sale via the online auction hall (9). They will be able to continue by making very good asset sales while new auctioneer companies (4) will be included in this structuring. Significant earnings will be obtained by organizing better in the auction sales and making great asset sales.

Rules and conditions to join the auction, identification information of the assets offered for sale and the auctioneer company (4) will be noticeably clear which will lead to a higher number of participants. The asset will have many advantages when it is ready for sale. There will be a higher demand for it since it fulfills all the legal requirements, and it is checked and controlled by several authorized bodies. The auctioneer company (4) will carry out advertising and promotion of the assets to be offered for sale via the online auction hall (9) and the auction house (5) in the national or international media.

The participants will be able to access all data regarding the asset when they type the name of the auctioneer company (4), work of art and artist in the web page search engine. They will make more investments by buying the assets offered for sale due to the transparency and reliability of the auctioneer company (4). They will be able to access asset information sold in the past years in the archive section. They will be able to find out the crediting rate given to the auctioneer company (4).

Conservation techniques involve intervening the artistic assets with active or passive methods without giving damage. It provides conservation of the artistic assets with the least harmless practices and the least change. Preventing the artistic assets from losing real value due to mechanical, chemical, physical, biological or different damages in time involve preserving under certain conditions and all precautions taken to protect and maintain them in their original state for a long time.

Environmental factors are taken under control and artistic assets are made more resistant against degradation and corrosion. Degradation and damage usually occur due to usage, transportation, preservation, and personal mistakes. Corrosion occurs due to chemical agents, insects, effects of heat and light, microorganisms, and mostly high ratio of moisture in the air. Conservation techniques involve repair and maintenance without harming the original structure of the artistic asset. Restoration processes involve assessing the conditions thoroughly and preserving the artistic assets.

Biological factors include microorganisms, insects, rodents, and reptiles. Physical factors include the effects of temperature, heat, and light. Chemical factors include the ratio of ambient moisture, trace elements in the air, inorganic polluting gases, particles, elements causing oxidation and corrosion, and other chemicals. Environmental factors are defined as fire and flood, natural disasters and wars, inappropriate use, theft, and damage caused by people. Areas of storage and preserving under optimum conditions should be ensured to delay and keep degradation, corrosion, and damage of the artistic assets at a limited level.

Before the auction, the artistic assets will go through diligent conservation and restoration processes and be prepared for the display exhibition. Every repair and maintenance process of the artistic asset will be controlled. Environmental factors will always be considered for storage and preservation of the artistic assets. Storehouses will be cleaned, isolated, and regularly disinfected against insects and microorganisms. In the storehouses, electricity will only be used for security system and there will be no water installation. Maintenance and repair will be conducted in the storehouses with certain periods.

Storehouses will be isolated against environmental factors and systems will be installed. Dehumidifying and drying device placed in the storehouses will be operated with certain intervals and temperature will be measured and transmitted to the control unit simultaneously. The artistic asset will be classified and packed considering its fragile structure, size and shape and then placed in the storehouse. Storage and preservation of the artistic assets in storehouses with private security will be carried out with care. Artistic assets that will take place in the display exhibition will be securely carried to the auction house (5) and then back to the storehouse.

What is claimed is:

1. A method for asset crediting, funding, depositing, auctioning and stock exchange wherein the current owners of precious metals, precious and semi-precious stones, jewelry and artistic assets (movable and precious assets that do not require registration according to the Obligations and Commercial Law of the location of the service provided/sold and the associated complementary law) will receive different service from the authorized body following the valuation report to be provided by the expertise committee; these will be pawned as a credit facility according to the Obligations and Commercial Law of the location of the service provided/sold and the associated complementary law and their reimbursement will be received as security by the authorized body after the payment of credit; there will be a sequence of financial transactions that will create added value for the asset owners in a short time; precious assets taken as security will be shown as collateral and credited by the international funding and insurance companies; funding companies insure these assets as collateral while insurance companies pay a deposit fee to the authorized body providing the depositing service for the movable assets; the asset owners will pay a service charge to the authorized body in return for the inclusion of assets in the auction; they will be able to sell the assets at their real value to the authorized body; the assets will be deposited for a fee in a safe environment appropriate for the qualities of the precious assets without destroying their original structure as long as they demand; the issuer companies will apply to the stock exchange institutions, the Capital Markets Board and A Borsa authorized bodies of the country to which they will provide service with the aim of offering the precious and semi-precious stones, jewelry and artistic assets to public; they will obtain approval for the asset guaranteed security (nominal) value and number, and for issuing in bearer form of the assets to be offered to public; wherein
the current owners of precious metals, precious and semi-precious stones, jewelry and artistic assets (movable and precious assets that do not require registration according to the Obligations and Commercial Law of the location of the service provided/sold and the associated complementary law) will receive a different service from the authorized body following the valuation report to be provided by the expertise committee;
these will be pawned as a credit facility according to the Obligations and Commercial Law of the location of the service provided/sold and the associated complementary law and their reimbursement will be received as security by the authorized body after the payment of credit; there will be a sequence of financial transactions that will create added value for the asset owners in a short time;
precious assets taken as security will be shown as collateral and credited by the international funding and insurance companies; funding companies will insure these assets as collateral while insurance companies will pay a deposit fee to the authorized body providing the depositing service for the movable assets;
the asset owners will pay a service charge to the authorized body in return for the inclusion of assets in the auction; they will be able to sell the assets at their real value to the authorized body; the asset will be deposited for a fee as long as they demand in a safe environment appropriate for the qualities of the precious assets without destroying its original structure;
the issuer companies will apply to the stock exchange institutions, the Capital Markets Board and A Borsa authorized bodies of the country to which they will provide service with the aim of offering the precious and semi-precious stones, jewelry and artistic assets to public; they will obtain approval for the asset guaranteed security (nominal) value and number, and for issuing in bearer form of the assets to be offered to public;
the specialized experts will prepare a valuation report as a result of a highly detailed investigation and research of the precious metals, precious and semi-precious stones, jewelry and artistic assets; they will be authorized in the expertise committee as they have adequate knowledge and experience; required information and documents will be provided to the expertise committee by working with private expertise companies operating in this field;
owners of artistic assets such as vintage jewelry and ornaments, works of art, articles of virtu, antique carpets and rugs, antiques and artefacts from past civilizations will apply to the expertise committee as an asset owner or collector; the identification information of the artistic asset owner will not be known even to the expertise committee and the specialized expert who will prepare the valuation report; the specialized expert will never bid for the artistic asset; valuation report will be prepared as a result of the investigation and research on the artistic asset;
the expertise committee will determine the estimated value after evaluating information like the condition, quality, rareness, provenance of the artistic asset, the person it is made for and the person who uses it; the authorized body will transfer the asset identification information to the computer after approving the estimated value of each artistic asset to be auctioned and the asset number;
the auctioneer company will prepare the file including information such as identification information of the precious and semi-precious stones, jewelry and artistic assets to be offered for sale, asset valuation report, asset's estimated value, information about auctioneer company, auction house, operating cost, auction manager fee, transportation fee, private security fee, staff and employee fee and commission fee and then will send this file to the authorized body; the authorized body will entitle the auctioneer company after evaluating the file information registered with the computer;
the auctioneer company will print asset's identification information such as auction house, seller's name, asset's estimated value, name of the work of art and artist, date of the work of art, category of the work of art, technical information, dimensions of the work of art, lot no, asset valuation report no, auctioneer company, starting/ending date of the auction on the label attached to the precious and semi-precious stones, jewelry and artistic assets;
the photographers commissioned at the auction house will take photos of precious and semi-precious stones, jewelry and artistic assets and prepare an auction catalogue; auctioneer company will share the auction catalogue through media; it will place the assets in a planned and programmed way in the auction house with due diligence and open a display exhibition before the auction; participants will examine the displayed assets and gain more detailed information;
the auction manager will request the identification information of the precious and semi-precious stones, jewelry, and artistic assets as a presentation file; the auction manager will offer the assets for sale in the auction house through open bidding/open underbidding as stated in the auction specifications; in the auction house, he/she will sell the assets to the participant at hammer price through open bidding with estimated value, Participants will be able to access necessary information regarding the assets offered for sale via a web page; buy and sell order transactions of the assets offered for sale will be carried out in the transaction platform with a defined algorithm;
the auctioneer company will not offer only precious and semi-precious stones, jewelry and artistic assets for sale in the auction house and it will be able to offer assets from different sectors for sale, as well; the expertise committee will determine an estimated value for the real estate, automobile and liquidated asset to be auctioned from other sectors; the authorized body will transfer the asset identification information to the computer after approving the estimated value of each asset and the asset number to be auctioned; the auctioneer company may carry out sales in more than one auction house simultaneously or at different times;
the asset owner will be able to give instruction to offer for sale and sell in the desired auction house the precious and semi-precious stones, jewelry and artistic assets kept in the storehouse through the transaction platform; the difference from other current auction houses is that the sale of assets in the central registration system is ordered and these are offered for sale in the auction house; when the participant desires to purchase the assets offered for sale through open bidding in the auction house, this is realized easily on the transaction platform;
in the auction house, the asset sale price will be determined by adding commission and tax amounts to the hammer price for the participant who offers the highest bid through open bidding with the asset's estimated price; the commission ratio to be received by the authorized body and the auctioneer company is defined in the auction specification; the microprocessor will transfer the asset's hammer price value to the investment account of the asset owner and the commission amounts to be received by the authorized body and the auctioneer company for the asset's hammer price to their investment accounts registered with the transaction platform.

2. The method for asset crediting, funding, depositing and offering for sale in the auction house according to claim 1, wherein
the participant will be able to see and examine the assets offered for sale in the online auction hall physically in the gallery hall; the participant will become a member to the online auction hall via the web site and choose the auction calendar to participate; a participant code and auction number will be sent when the registration is approved; the participant will make a down payment as defined in the registered auction hall; the amount of the down payment will differ according to the sales department; before the auction begins, participants will participate in the sale in the auction hall carried out live via internet by entering the participation code and auction number on the auction department page;
in the online auction hall, the asset sale price will be determined by adding commission and tax amounts to the bid for the participant who offers the highest bid through open bidding with the asset's estimated price; the commission ratio to be received for the bid by the authorized body and the auctioneer company is defined in the auction specification; the microprocessor will transfer the asset's bid value to the investment account of the asset owner and the commission amounts to be received by the authorized body and the auctioneer company for the asset's bid to their investment accounts registered with the transaction platform; only the buyer's information will be added to the asset's identification information; the buyer may keep the bought asset in the storehouse or offer for sale again; the asset will gain value without being damaged and by continuously changing hands;
for asset owners, the issue of conservation and restoration is a primary concern; the restoration company will carry out the repair and maintenance processes with due diligence and without harming the original structure of the artistic asset; the specialized experts will carry out conservation processes of the artistic assets kept in storehouses with defined periods and ensure these assets to be more precious; all assets kept in the storehouses will be actively controlled 24/7 with the help of a cutting-edge technological security system;
the precious and semi-precious stones, jewelry and artistic assets will be kept in storehouses after the most comprehensive private insurance contract is made; when any damage is detected with the assets, the cost of restoration will be reimbursed by the insurance company; the asset owner will receive the down payment specified in the contract as reimbursement if the asset is stolen or lost; various processes will be covered by the private insurance policy such as defining every kind of fire and natural disaster risk groups that can occur in the storehouse and the auction house, transportation processes, maintenance and repair processes, delivery of the damage assessment report, prevention of theft, legal consultancy and working with the best reassurance companies;
the auctioneer company will draw up a private insurance contract for all risky situations that can occur during and after transportation of the precious and semi-precious stones, jewelry and artistic assets to be sold to the auction house; the authorized body will secure the contractual rights of the beneficiary by drawing up an asset pledge contract due to the risky situations that can occur with the assets; assets will be offered for sale by drawing up a private insurance contract;
all transactions of the assets kept in storehouses will be registered with the accounts opened on behalf of those assets; transaction fees such as specialized expertise fee, asset's estimated value, asset's pledge contract amount, the deposited down payment, authorized body and auctioneer company commission rate, the received tax amount, private insurance policy fee, conservation and restoration expenses, transportation and storage fees will be registered with the account opened on behalf of the asset; if the asset is received by the asset owner or sold, the account opened on behalf of the asset will be removed from the registration and closed;
the authorized body will give a credit rating according to the organization and sales performance of the auctioneer companies in the auction house and online auction halls; it will decide whether it will be an auctioneer company again or not; it will evaluate the credit ratings and allow the auctioneer companies to carry out sales in A Borsa auction houses according to this.

3. The method for asset crediting, funding, depositing and offering for sale in the online auction hall according to claim 1, wherein
on A Borsa, there will be a stock exchange where precious and semi-precious stones, jewelry and artistic assets will be traded; the issuer company will apply to the authorized body of A Borsa to offer assets to public; the authorized body of A Borsa will evaluate the application and register it as issuer company after approval; the expertise committee will determine the estimated value of each asset in the collection of the issuer company; the issuer company will prepare a file including the asset identification information of the collection to be offered to public and the commission amount to be taken from the asset's value of issue and deliver it to the authorized body of A Borsa;
the authorized body of A Borsa will transfer the estimated value of each asset in the collection to the computer after approving the asset owners and asset identification information; the microprocessor will add each asset's estimated value in the collection and find the price of issue of the asset and then register this; it will find the asset fund value by multiplying each asset's estimated value by 100 and then dividing by its price of issue and then register this; it will find the (nominal) value of the asset guaranteed security by dividing the asset's price of issue by the number of the asset guaranteed securities and then register this;
the issuer company will print on the asset guaranteed securities the identification information of the asset such as the issue date of the asset, barcode of the asset, date of asset's entering/exiting the exchange list, (nominal) value and number of asset guaranteed security with the printing process to be applied; asset guaranteed securities equal to the asset value of issue will be offered to public; asset guaranteed securities will be issued in bearer form; the authorized body of A Borsa will carry out the quota transaction of the asset guaranteed securities on A Borsa; the microprocessor will transfer the estimated value of each asset to the investment account of the asset owner registered with the transaction platform after issuing the asset guaranteed securities;
the account owners will be able to buy with the (nominal) value of the asset guaranteed security on the date of entering the exchange list; beginning from the date of entering the exchange list until the date of exiting from it, they will invest by buying at the asset's current stock exchange price while it is being traded on A Borsa; buy and sell order transactions for the asset guaranteed securities will be carried out with a defined algorithm on the transaction platform through stockbrokers, commercial banks, and investment and development banks; account owners will be able to buy and sell the asset traded on A Borsa at its current stock exchange price when they want to buy or sell asset guaranteed securities;
account owners will carry out processes such as monitoring immediate data of the traded asset guaranteed securities and buy-sell order transactions easily and quickly on the transaction platform through A Borsa; they will be able to review the volume, depth, simultaneous level analysis of the asset guaranteed securities; buy and sell orders can be given with an optimum level and transactions can be transferred to A Borsa safely; the status of the given orders will be questioned as pending, realized, cancelled and unrealized; instructions to improve and cancel the order transactions can be given and information such as the quantity, current value, profit and loss information of the asset guaranteed securities can be accessed through investment account;
on the date of asset's exiting the exchange list, the asset guaranteed securities will be removed from the A Borsa exchange list and closed for transactions; on the date of asset's exiting the exchange list, the microprocessor will find the asset stock exchange value by multiplying the final quotation of the asset on its last transaction day with the number of asset guaranteed securities and then register this; the authorized body of A Borsa will declare the auction beginning/ending date after the approval of asset stock exchange value; the microprocessor will find the asset's auction opening price by multiplying the asset stock exchange value with each asset fund value and then register this;
the auctioneer company will print asset's identification information such as each asset's auction opening price, asset owner, name of the work of art and artist, date of the work of art, category of the work of art, technical information, dimensions of the work of art, lot no, asset valuation report no, auctioneer company, and starting/ending date of the auction on the label attached to the assets included in the collection; it will open a display exhibition in the stock exchange auction house for the assets included in the collection that is removed from the A Borsa exchange list; participants will examine the displayed collection assets in the stock exchange auction house to gain more detailed information;
the auctioneer company will realize the live auction in the stock exchange auction house; the auction manager will offer for sale each asset through open bidding at its auction opening price; the auction manager will sell to the participant who offers the highest bid for each asset at its hammer price; the participant will buy at asset's sale price determined by adding commission and tax amounts to the hammer price; each asset that could not be sold through open bidding will be sold to the secondary markets at its auction opening price; the microprocessor will transfer the commission amounts to be received for the asset hammer price by the authorized body and the auctioneer company for the asset's hammer price to their investment accounts registered with the transaction platform;
the microprocessor will find the asset's auction value by adding the hammer price of each asset that is sold and the auction opening price of each asset that is not sold and then register this; it will find the asset's auction earning value by subtracting the asset's stock exchange value from the asset's auction value and then register this; it will find the asset owner's earning value by multiplying the auction earning value with a defined percentage and then register this; it will find the account owner's earning value by subtracting the asset owner's earning value from the auction earning value and then register this; it will find each asset's earning value by multiplying asset owner's earning value with each asset's fund value and then register this; it will transfer each asset's earning value to the investment account of the asset owner registered with the transaction platform;
the microprocessor will find the (final) value of the asset guaranteed security by adding the asset's price of issue to the account owner's earning value and dividing this by the number of the asset guaranteed securities and then register this; it will find the transaction closing values by multiplying the number of the asset guaranteed securities held by the account owners on the date of asset's exiting the exchange list with the (final) value of the asset guaranteed security and then register this; the transaction closing values of the account owners will be transferred to their investment accounts registered with the transaction platform.

4. The method for asset crediting, funding, depositing and offering for sale in the online auction hall according to claim 2, wherein
on A Borsa, there will be a stock exchange where precious and semi-precious stones, jewelry and artistic assets will be traded; the issuer company will apply to the authorized body of A Borsa to offer assets to public; the authorized body of A Borsa will evaluate the application and register it as issuer company after approval; the expertise committee will determine the estimated value of each asset in the collection of the issuer company; the issuer company will prepare a file including the asset identification information of the collection to be offered to public and the commission amount to be taken from the asset's value of issue and deliver it to the authorized body of A Borsa;
the authorized body of A Borsa will transfer the estimated value of each asset in the collection to the computer after approving the asset owners and asset identification information; the microprocessor will add each asset's estimated value in the collection and find the price of issue of the asset and then register this; it will find the asset fund value by multiplying each asset's estimated value by 100 and then dividing by its price of issue and then register this; it will find the (nominal) value of the asset guaranteed security by dividing the asset's price of issue by the number of the asset guaranteed securities and then register this;
the issuer company will print on the asset guaranteed securities the identification information of the asset such as the issue date of the asset, barcode of the asset, date of asset's entering/exiting the exchange list, (nominal) value and number of asset guaranteed security with the printing process to be applied; asset guaranteed securities equal to the asset value of issue will be offered to public; asset guaranteed securities will be issued in bearer form; the authorized body of A Borsa will carry out the quota transaction of the asset guaranteed securities on A Borsa; the microprocessor will transfer the estimated value of each asset to the investment account of the asset owner registered with the transaction platform after issuing the asset guaranteed securities;
the account owners will be able to buy with the (nominal) value of the asset guaranteed security on the date of entering the exchange list; beginning from the date of entering the exchange list until the date of exiting from it, they will invest by buying at the asset's current stock exchange price while it is being traded on A Borsa; buy and sell order transactions for the asset guaranteed securities will be carried out with a defined algorithm on the transaction platform through stockbrokers, commercial banks, and investment and development banks; account owners will be able to buy and sell the asset traded on A Borsa at its current stock exchange price when they want to buy or sell asset guaranteed securities;
account owners will carry out processes such as monitoring immediate data of the traded asset guaranteed securities and buy-sell order transactions easily and quickly on the transaction platform through A Borsa; they will be able to review the volume, depth, simultaneous level analysis of the asset guaranteed securities; buy and sell orders can be given with an optimum level and transactions can be transferred to A Borsa safely; the status of the given orders will be questioned as pending, realized, cancelled and unrealized; instructions to improve and cancel the order transactions can be given and information such as the quantity, current value, profit and loss information of the asset guaranteed securities can be accessed through investment account;
on the date of asset's exiting the exchange list, the asset guaranteed securities will be removed from the A Borsa exchange list and closed for transactions; on the date of asset's exiting the exchange list, the microprocessor will find the asset stock exchange value by multiplying the final quotation of the asset on its last transaction day with the number of asset guaranteed securities and then register this; the authorized body of A Borsa will declare the auction beginning/ending date after the approval of asset stock exchange value; the microprocessor will find the asset's auction opening price by multiplying the asset stock exchange value with each asset fund value and then register this;
the auctioneer company will print asset's identification information such as each asset's auction opening price, asset owner, name of the work of art and artist, date of the work of art, category of the work of art, technical information, dimensions of the work of art, lot no, asset valuation report no, auctioneer company, and starting/ending date of the auction on the label attached to the assets included in the collection; it will open a display exhibition in the stock exchange auction house for the assets included in the collection that is removed from the A Borsa exchange list; participants will examine the displayed collection assets in the stock exchange auction house to gain more detailed information;
the auctioneer company will realize the live auction in the stock exchange auction house; the auction manager will offer for sale each asset through open bidding at its auction opening price; the auction manager will sell to the participant who offers the highest bid for each asset at its hammer price; the participant will buy at asset's sale price determined by adding commission and tax amounts to the hammer price; each asset that could not be sold through open bidding will be sold to the secondary markets at its auction opening price; the microprocessor will transfer the commission amounts to be received for the asset hammer price by the authorized body and the auctioneer company for the asset's hammer price to their investment accounts registered with the transaction platform;
the microprocessor will find the asset's auction value by adding the hammer price of each asset that is sold and the auction opening price of each asset that is not sold and then register this; it will find the asset's auction earning value by subtracting the asset's stock exchange value from the asset's auction value and then register this; it will find the asset owner's earning value by multiplying the auction earning value with a defined percentage and then register this; it will find the account owner's earning value by subtracting the asset owner's earning value from the auction earning value and then register this; it will find each asset's earning value by multiplying asset owner's earning value with each asset's fund value and then register this; it will transfer each asset's earning value to the investment account of the asset owner registered with the transaction platform;
the microprocessor will find the (final) value of the asset guaranteed security by adding the asset's price of issue to the account owner's earning value and dividing this by the number of the asset guaranteed securities and then register this; it will find the transaction closing values by multiplying the number of the asset guaranteed securities held by the account owners on the date of asset's exiting the exchange list with the (final) value of the asset guaranteed security and then register this; the transaction closing values of the account owners will be transferred to their investment accounts registered with the transaction platform.
